(19) United States
(12) Patent Application Publication
(10) Pub. No.: US 2009/0188971 A1
(43) Pub. Date: Jul. 30, 2009

(54) METHOD FOR SECURING AN ARTICLE AND SYSTEM FOR USING SUCH A METHOD

(76) Inventors: Marcel Chambon, Saint Laurent du Var (FR); Frederic Chambon, Saint Laurent du Var (FR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/297,890

(22) PCT Filed: Apr. 23, 2007
(86) PCT No.: PCT/FR07/00679

§ 371 Date: Jan. 29, 2009

(30) Foreign Application Priority Data
Apr. 21, 2006 (FR) 06/03530

(51) Int. Cl. G06F 17/00; G08B 13/14

(52) U.S. Cl. 235/375; 340/568.1; 340/5.8

(57) ABSTRACT

A method for securing an article includes the following steps according to which a contactless electronic chip is customized using a management code, this management code possibly being read by means of an appropriate contactless reader of the chip, and said chip is positioned in said article, together with a system for using such a method. The method is characterized in that it also comprises the following steps according to which a secondary secret code associated with the management code is defined, said secondary code being known to the article purchaser, and the authenticity of the article is verified by reading the management code and verifying that the person carrying or wearing the article knows the secondary code. The method is particularly applicable to security of deluxe articles.

### FIELD OF INVENTION

The invention relates to a method for securing an article and, in particular, a deluxe article, according to which—a contactless electronic chip is customized using a management code, said management code possibly being read by means of an appropriate contactless reader, and—said chip is positioned in said article. The invention further relates to a system for implementing said method.

### BACKGROUND

The articles and, in particular, the deluxe articles, are often the subject of thefts and counterfeits. The damage supported by owners of the trademarks corresponding to the counterfeit or stolen articles is high and keeps on rising with globalization. It therefore seems necessary to definitively secure any article, in particular deluxe articles, via secure means, and to provide, whenever possible, the traceability thereof.

It has already been suggested to position, in the deluxe articles, coded electronic labels comprising a digital marker that can be read by contactless readers. The presence of such a label associated to an article indicates that the article is probably authentic and the absence thereof, that said article is probably a counterfeit. However, said method of securing is simplistic. The securing is not sufficient and it is not possible to provide the traceability of the articles. Thus, if authentic articles are stolen with the labels thereof, then, for example, checked when passing through customs, said articles will be considered authentic and the theft will not be detected. Moreover, some counterfeiters have acquired the required technology for manufacturing electronic labels. Said counterfeiters implant, in counterfeit products, chips themselves counterfeit, which makes it even more difficult to determine the counterfeit.

### SUMMARY

In view of the above, a problem that the invention proposes to solve is to produce a method for securing articles, in particular deluxe articles, which makes it possible to verify with certainty the authenticity of said articles and to provide the traceability thereof, the management of said method being however simple.

The first aim of the solution proposed by the invention to said problem posed is a method for securing an article comprising the following steps according to which:

a contactless electronic chip is customized using a management code, said management code possibly being read by means of an appropriate contactless reader of the chip; and

said chip is positioned in said article;

and, characterized in that it further comprises the following steps according to which:

a secondary secret code associated to the management code is defined, said secondary code being known to the purchaser of the article; and

the authenticity of the article is verified by reading the management code and by verifying that the person carrying or wearing the article knows the secondary code.

The second aim is a system for securing an article; and a contactless electronic chip positioned in said article, said chip being customized by a management code, said management code possibly being read, by means of an appropriate contactless reader of the chip, and characterized in that a secondary secret code is defined and associated to the management code, said secondary code being known by the purchaser of the article, and in that the authenticity of the article is suitable for being verified by the person carrying or wearing the article knowing said secondary code.

Thus, according to the invention, the contactless electronic chip

positioned in the article comprises a public: management code, and consequently can be read by appropriate readers. However, in the invention, a secondary code is associated to said management code. Said secondary code is, itself, not accessible to the public and is not encoded on the chip. Said secondary code is on the other hand known by the purchaser of the article, referenced in the database and associated to the management code of said purchased article. When the authenticity of the article must be verified, the knowledge, by the person carrying or wearing the article, of the secondary code, is verified. If this verification proves to be positive, i.e. if the person carrying or wearing the article effectively has good knowledge of the secondary code, then the article is authentic and has been the subject of an actual marketing. In the opposite case, the article is not authentic or was the subject of a theft.

Advantageously, the management code is a numeric or alphanumeric code which is specific to the article; the management and secondary codes are recorded in a database and, for verifying that the person carrying or wearing the article knows the secondary code, said person carrying or wearing the article reveals said secondary code and the correspondence between said secondary code and the management code is verified in the database; the chip is customized by a primary code and in that said primary code is recorded in a database; the database further comprises the information relating to the identity of the purchaser of the article, for example, his date of birth, and advantageously his name and first name; the chip consists of a capsule integrating a semiconductor substrate connected to an antenna; and the chip is lodged or included in a cavity of the article.

### BRIEF DESCRIPTION OF THE DRAWING(S)

The invention will understood better from reading the following non-limiting description, drafted relating to the appended drawings, wherein:

FIG. 1 shows, schematically, a ring secured according to the invention;

FIG. 2 is a representation of the management code recorded in a chip for securing an article according to the invention;

FIG. 3 is a diagram showing the various steps for securing an article according to the method of the invention; and

FIG. 4 shows, schematically, the system according to the invention.

### DETAILED DESCRIPTION OF THE PREFERRED EMBODIMENT(S)

The method according to the invention is a method for securing articles. Said articles are in particular deluxe articles. It may concern pieces of jewelry or timepieces such as pendants, rings, necklaces, bracelets, earrings or watches; leather goods such as wallets or handbags or pieces of luggage; clothes or associated articles such as belts or glasses; articles of decoration or sport such as bicycles or medals; or else, works of art such as sculptures, bronzes or paintings. It may also concern bottles, in particular of wine or of Champagne; valuable cutlery such as knives; or even much bulkier articles such as vehicles, in particular, motorcycles, automobiles, or trucks. More generally, it concerns any metal, wooden or textile articles which have a certain value, and are therefore likely to be the subject of a counterfeit.

According to the invention, the articles are secured by means of a contactless electronic chip. Such chips are for example chips known as RFID or contactless electronic labels. They comprise a semiconductor substrate, said substrate being connected to the terminals of an antenna for a contactless communication with an appropriate reader of the chip. The semiconductor substrate may consist of a microcontroller comprising for example ROM and electrically erasable memories of the EEPROM type. In an alternative embodiment, it may consist of a single memory of the type that is found in pre-paid telephone cards or in low-cost electronic labels. As an example of chips, the chips marketed under the trademark Destron™ will be cited. Said chips consist of a semiconductor substrate connected to an antenna, the substrate and antenna assembly being included in a glass or plastic capsule. The dimensions of said chips are much reduced, 12 to 28 mm in length for 2.1 to 3.5 mm in diameter.

According to the invention, the chip is positioned fixed in the article. It may be included inside the article or placed at the surface thereof.

Advantageously, the chip is positioned such as to always receive the contactless communication with an appropriate reader and so as to be destroyed during any attempt of removal or replacement.

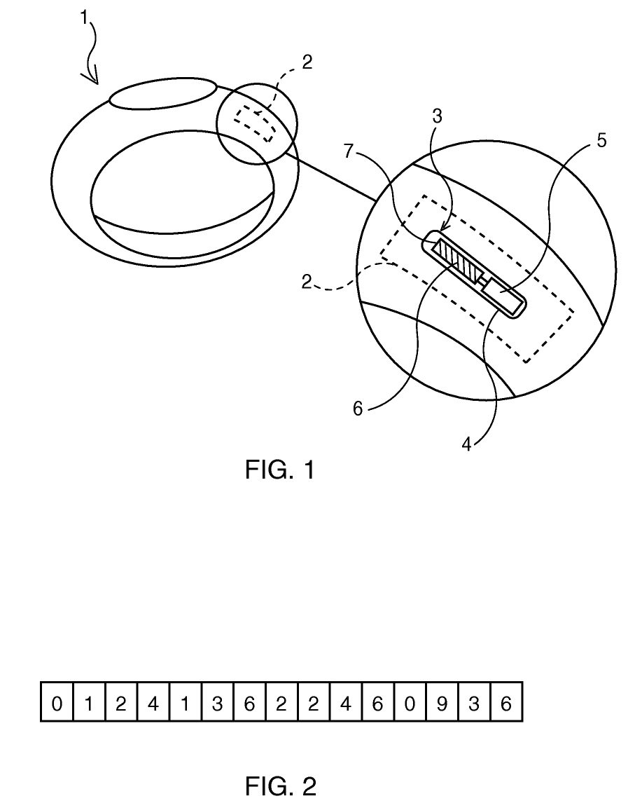

An example of secured article according to the invention is presented in FIG. 1. It concerns a ring 1. Said ring 1 is for example produced in a precious metal such as gold. It comprises, according to the invention, a cavity 2. Said cavity 2 comprises a chip 3 of the type of same above described, consisting of a glass capsule 4 and integrating a semiconductor substrate 5 with memory connected to an antenna 6 coiled about a core 7. Said capsule 4 is covered with a fine layer of gold and the cavity 2 is filled with a gold-based binder such that the chip 3 is not visible from the outside of the ring 1. However, although invisible, the chip 3 can be read by an appropriate reader. It has even been demonstrated that, surprisingly, the act of including the chip 3 in a cavity 2 of the ring 1 and of covering said chip with a fine film of gold, did not result in a significant increase in the coupling distance between the reader and the chip 3. Thus, the memory of the chip 3 can be read at reader/chip coupling distances of approximately 50 cm.

By way of examples, the chip can be positioned, in the windshield or steering wheel of a vehicle, the chip being covered with a resin withstanding temperatures reaching 190° C., resulting in the destruction of the chip in the event of an attempt of removal or replacement. Likewise, in the case of Champagne bottles, the chip is positioned above the cork, between the cork and the iron plate, also known as a capsule, held on the cork by the preformed wire, known as a wire-cap. Said wire-cap is taken up on the flange of the neck and holds the cork which therefore can no longer be ejected by the pressure in the bottle, any opening of the wire-cap automatically resulting in the destruction of the glass envelop of the chip and therefore of the chip itself.

The chip is, according to the invention, suitable for receiving a so-called management code. The recording of said management code in the chip is known as customization.

Management codes are numeric or alphanumeric codes over a limited number of bits in the memory of the chip. In the example of FIG. 2, the management code consists of 15 figures between 0 and 9. It is generated randomly and corresponds to a given article.

Advantageously, it has a signification in relation to the article. For example, the signification of the digits of the management code presented in said figure is the following, said digits being considered from left to right:

“0 1 2”: corresponds to the trademark under which the article is distributed;

“4 1 3”: corresponds to the type of article, for example to leather goods;

“6 2”: corresponds to the sub-type of the article, for example a bag;

“2 4”: corresponds to a feature of the bag, for example the blue color of the bag;

“6 0”: corresponds to the batch of which the blue bag forms part of;

“9 3 6”: corresponds to the article itself, the 936th from batch 60.

In practice, the trademark owners manufacturing the articles have a large scope for defining the management codes. It is however important that said codes relate to the article and that the encoding possibilities are high enough in view of effectively differentiating the articles from one another.

Advantageously, the management code is encrypted according to known algorithms.

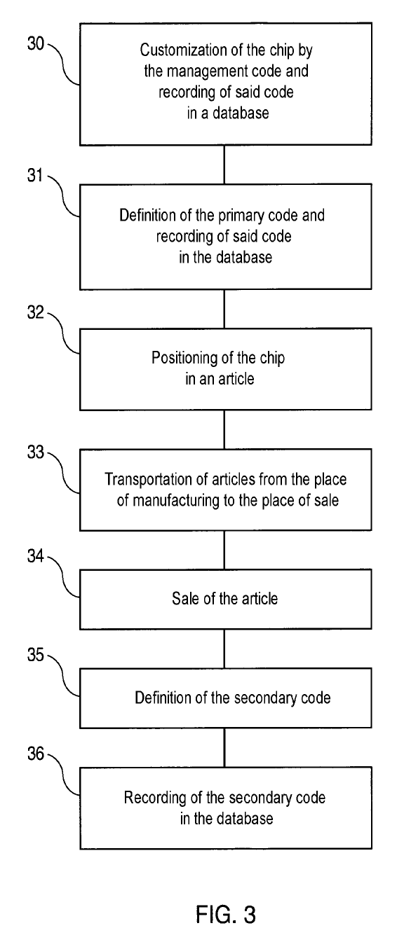

The articles are generally manufactured in a specific manufacturing plant. The chips are for example customized (FIG. 3, step 30) or encoded in said plant. They are generally positioned in the articles (FIG. 3, step 32), once customized, when said articles are finished. Thus, the articles manufactured are all, on leaving the manufacturing plant, equipped with a chip comprising a management code, advantageously specific to the batch and/or the article itself.

Before the transportation of the finished articles (FIG. 3, step 33), in particular towards a store for selling the articles, advantageously a random primary code is allocated to each article (FIG. 3, step 31). Said primary code is not necessarily recorded in the chip. Said primary code is known, for example, by the owner of the distribution trademark of the articles and/or by the manufacturer of the articles and/or by the store for which said articles are intended. It is contained in a database, for example, managed by the owner of the trademark and it is associated with the management code of the article considered.

Advantageously, the primary code is encrypted according to known algorithms.

If one or more articles of a batch are stolen during the transportation thereof from the manufacturing plant to the store, then said articles are identified by the management code thereof. For example, if approximately ten articles of a batch of approximately one hundred articles transported from a manufacturing plant to a store are stolen, then the missing articles are simply identified in the following manner. The chips of the 90 articles that were not stolen are read and the management codes thereof are detected. The management codes of said 90 articles are transmitted for example via a link of the TCP/IP type to the owner of the trademark who has a list of the 100 articles of the batch. He deduces therefrom, the 10 missing articles. The latter are identified in the database, on one hand, by the management code thereof and, on the other hand, by the random primary code thereof. Thus, the traceability of the articles is provided during the journey thereof from the manufacturing plant to the place of sale thereof.

According to a later step of the method according to the invention, a secondary secret code is defined associated to the management code (FIG. 3, step 35), said secondary code being known by the purchaser of the article.

Thus, when the article is acquired by a purchaser in a store (FIG. 3, step 34), a secondary secret code is defined, either by the person having acquired the article or by the salesperson. In the case where the salesperson defines the code, said code is communicated to the purchaser of the article.

The secondary code is a numeric or alphanumeric code comprising for example 4 digits. Said code may in particular contain data that is indicative to the country of origin of the sale of the article, or even the date of birth of the purchaser of the article.

Advantageously, the secondary code is encrypted according to known algorithms.

Said code is then communicated, for example, via an Internet type IT network, to the owner of the trademark or else preferably to a company managing the database containing the management codes. It is integrated into said database and associated to the management code corresponding to the article (FIG. 3, step 36).

Furthermore, during the sale in the store of the article, a customer sheet may be established, said sheet mentioning at least the date of birth of the purchaser and advantageously his name, first name and date of birth. Said information is advantageously transmitted to the owner of the database and recorded in relation to the management code of the article, and of the secondary code.

If, at a later date, the authenticity of the article must be verified, said authenticity is verified, according to the invention, by verifying that the person carrying or wearing the article knows the secondary code.

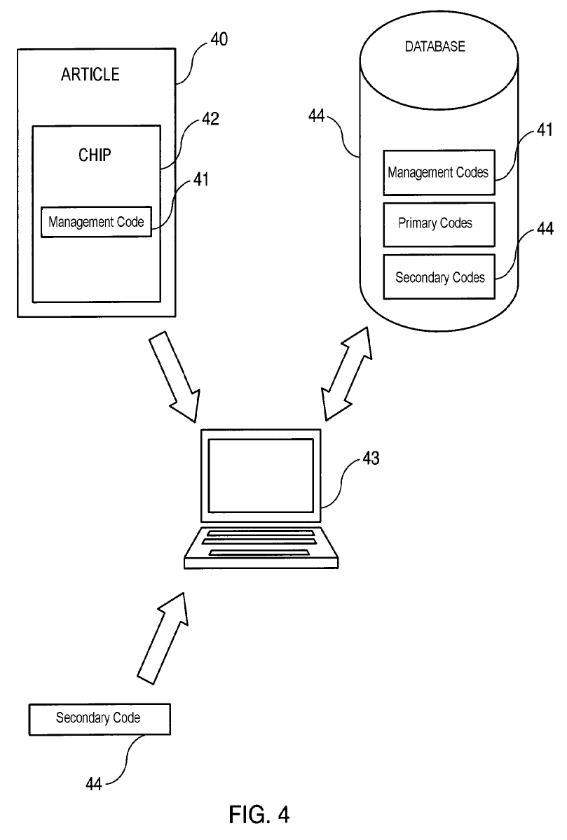

FIG. 4 presents the various means of the system according to the invention intended for verifying the authenticity of an article in particular at the level of the customs.

In the case where, for example, the person carrying or wearing a trademark article is stopped at the customs, and that the customs officers wish to verify the authenticity of the article and the fact that said article is under no circumstance the subject of a theft, then the customs officer approaches a contactless reader of the article 40 in view of reading the management code 41 normally contained in the chip 42 of the article.

If no chip is detected, this means that the article is obviously fraudulent. Either said article is a counterfeit and it does not have a chip. Or the article is not a counterfeit but the chip has been removed from the article, voluntarily, In both cases, the customs officer will know that the article must be seized.

If a chip is detected but that said chip does not contain a management code, then, just as before, the article will be immediately considered as fraudulent.

It is however possible that the chip is authentic and equipped with a management code but that the article was the subject of a theft during the transportation thereof prior to the sale. In this case, the database will have indicated that the article corresponding to the given management code has been stolen. The customs officer will be informed of this situation and the article will be considered as stolen and will be the subject of a seizure.

If a chip is detected, and that said chip is equipped with a management code, then said management code 41 is read by the reader of the customs officer then is introduced into a computer 43 connected, via an Internet type IT network, to the database 45 of the owner of the trademark corresponding to the article or of the company managing the database. Advantageously, the contactless reader is connected directly to the computer of the customs officer such that same does not have to input the code read by the reader. The code is therefore communicated, by the IT network, from the computer of the customs officer, to the manager of the database containing the management codes, in practice the owner of the trademark or an independent company. The connection of the computer of the customs officer to the database may be carried out via an Internet site of the owner of the trademark or of the company managing the database, by means of a secured access, in particular via password, the data exchanged between the computer of the customs officer and the owner of the database preferably being encrypted according to known algorithms.

Once the manager of the database has received the management code 41, he searches, in the database, the existence of said code. If no secondary code 44 is associated to said management code, then the article was stolen prior to the sale thereof. If, however, the management code is effectively associated to a secondary secret code, the manager of the database asks the customs officer that the secondary code 44 be revealed by the person carrying or wearing the article. The customs officer therefore asks said person carrying or wearing the article to enter the secondary code for example with the keyboard of the computer or by means of a secondary keyboard. The secondary code entered is transmitted to the manager of the database. The verification of said secondary code is carried out. If the secondary code is correct, a message is sent to the customs officer indicating a correspondence and the authenticity of the article is validated. In the opposite case, the article is declared stolen and the customs officer seizes the article.

Furthermore, if the date of birth and, advantageously, the name and first name of the owner of the article were associated, during the sale, to the secondary code, in the database, said information is advantageously transmitted to the customs officer who will be able to verify that the identity of the person carrying or wearing the article revealed by the passport thereof or any other identity document indeed corresponds to the identity transmitted by the database.

Thus, not only is the authenticity of the article verified but also the traceability of said article. It is therefore possible to know if the article is counterfeit or stolen. It is furthermore possible to know if the theft was carried out before the effective sale of the object or else after said sale.

Furthermore, the method for securing according to the invention makes it possible to label the articles, in particular the articles of jewelry, by replacing the stamp with the chip. The introduction of said chip in the article thus offers a traceability of the article as well as a reference regarding the origin thereof.

1. A method for securing an article comprising the following steps according to which:
a contactless electronic chip is customized using a management code, said management code possibly being read by means of an appropriate contactless reader of the chip; and
said chip is positioned in said article;
and, wherein it further comprises the following steps according to which:
a secondary secret code associated to the management code is defined, said secondary code being known by the purchaser of the article; and
the authenticity of the article is verified by reading the management code and by verifying that the person carrying or wearing the article knows the secondary code.

2. The method of claim 1, wherein the management code is a numeric or alphanumeric code which is specific to the article.

3. The method of claim 1, wherein the management and secondary codes are recorded in a database and wherein, for verifying that the person carrying or wearing the article knows the secondary code, said person carrying or wearing the article reveals said secondary code and the correspondence between said secondary code and the management code is verified in the database.

4. The method of claim 1, further comprising a step according to which the chip is customized by a primary code and that said primary code is recorded in a database.

5. The method of claim 4, wherein the database further comprises the information relating to the identity of the purchaser of the article, for example, his date of birth, and advantageously his name and first name.

6. The method of claim 4, wherein the database further comprises the information relating to the identity of the purchaser of the article, for example, his date of birth, and advantageously his name and first name.

7. The method of claim 1, wherein the chip comprises a capsule integrating a semiconductor substrate connected to an antenna.

8. The method of claim 7, wherein the chip is included in a cavity of the article.

9. The method of claim 1, wherein the management code, the secondary code and the primary code are encrypted according to known algorithms.

10. A system for securing an article comprising
an article; and
a contactless electronic chip positioned in said article, said chip being customized by a management code corresponding to said article, said management code possibly being read by means of an appropriate contactless reader of the chip, and
wherein a secondary secret code is defined and associated to the management code, said secondary code being known by the purchaser of the article, and in that the authenticity of the article is suitable for being verified by the person carrying or wearing the article knowing said secondary code.

11. The system of claim 10, wherein the article is a ring and in that the chip is lodged in a cavity of the ring.

12. The system of claim 10, wherein the article is a vehicle and wherein the chip is lodged at the level of the steering wheel or windshield of the vehicle.

13. The system of claim 9, wherein the article is a bottle of champagne and wherein the chip is lodged above the cork, between the cork and the iron plate, also known as the capsule, held on the cork via a preformed wire, known as a wire-cap.
